(19) United States
(12) Patent Application Publication
(10) Pub. No.: US 2024/0287414 A1
(43) Pub. Date: Aug. 29, 2024

(54) Compositions and Methods for Reducing Pet Hair Adhesion to Fabric

(71) Applicant: Colgate-Palmolive Company, New York, NY (US)

(72) Inventors: Cesar GAZGA URIOSTE, Xochimilco (MX); Tilo Poth, Mexico City (MX); Jose Bucio, Mexico City (MX); Maria Eugenia Rojo Dieguez, Mexico D.F. (MX)

(73) Assignee: Colgate-Palmolive Company, New York, NY (US)

(21) Appl. No.: 18/589,027

(22) Filed: Feb. 27, 2024

Related U.S. Application Data
(60) Provisional application No. 63/487,168, filed on Feb. 27, 2023.

(51) Int. Cl. C11D 3/30; C11D 3/37; D06M 13/463; D06M 15/63

(52) U.S. Cl. CPC C11D 3/30; C11D 3/373; D06M 13/463; D06M 15/63; D10B 2401/16

(57) ABSTRACT

Described herein are fabric care compositions that reduce or prevent the adhesion of pet hair to fabric. Methods of making and using these compositions for reducing or preventing the adhesion of pet hair to fabric, are also described.

### CROSS-REFERENCE TO RELATED PATENT APPLICATIONS

This application claims priority to U.S. Appl. No. 63/487,168, entitled, “Compositions and Methods for Reducing Pet Hair Adhesion to Fabric,” filed on Feb. 27, 2023, the content of which is incorporated herein by reference in its entirety for all purposes.

### BACKGROUND

Fabric care compositions are generally used during the rinse or drying cycle of a laundry process to improve various characteristics of laundered fabric articles, such as softness, fragrance, static reduction, and ease of ironing. Typically, liquid fabric care compositions are used in the rinse cycle and solid fabric care compositions are used in the drying cycle, usually incorporated onto woven substrates placed in the laundry dryer.

The adherence of pet hair to fabrics is a phenomenon that annoys many pet owners. Particularly the persistence of pet hair that gets attached during the daily routine poses hygienic and esthetic challenges. State of the art technologies target hair removal during washing or attempt to dissolve the hair by peroxides also during washing. The described methods do, however, not fit the fabric with a repellant shielding effect. Other technologies apply actives at high temperatures during the drying process by literally melting them on the fabric. Again other approaches describe the spraying of ingredients onto the fabric.

The interaction between pet hair and the fabric can be manifold. A fairly large proportion of it, however, turned out to be based on electrostatic charge and the resulting attractive forces between the fabric and the hair that are distinguished by opposite electric surface potentials.

Accordingly, it would be useful to develop more cost effective fabric care compositions which reduce or prevent the adhesion of pet hair to fabric. Embodiments of the present invention are designed to meet this and other ends.

### BRIEF SUMMARY

This summary is intended merely to introduce a simplified summary of some aspects of one or more embodiments of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts as a prelude to the detailed description below.

This invention describes a technology that makes fabrics less susceptible to hair adherence so that exposure during daily routine leads to less hair being caught at the surface and to an easier removal of the hair that was eventually attached and/or adhered. The invention at hand therefore describes a pet hair repellent and shielding technology that is applied during the washing cycle in the form of a fabric softener.

Surprisingly, adding cationic surfactants and polymers to the washing process led to a substantial and persistent reduction of pet hair adherence. It is important to mention that this technology allows the application of the surface potential modifying substances from an aqueous solution and can thus be integrated into a laundry process. This is possible because the used substances selectively target the fibers of the fabric in a polar solvent like water.

This technological approach proved to be superior to state-of-the-art solutions including the melting process using dryer sheets as described above.

Some embodiments of the present invention provide a liquid fabric care composition comprising: water; a dialkylester triethanol ammonium methyl sulfate; and an effective amount of an anti-adhesion component comprising: a silicone and/or a copolymer of acrylamide and diallyldimethylammonium chloride, wherein the anti-adhesion component is present in an amount effective to reduce the adhesion of pet hair to a fabric.

Other embodiments of the present invention provide a method of reducing or preventing the adhesion of pet hair to a fabric, the method comprising: applying to a fabric a liquid composition comprising: water; a dialkylester triethanol ammonium methyl sulfate; and an effective amount of an anti-adhesion component comprising: a silicone and/or a copolymer of acrylamide and diallyldimethylammonium chloride, wherein the anti-adhesion component is present in an amount effective to reduce the adhesion of pet hair to a fabric.

In another embodiment, the fabric care composition has a viscosity from 30 to 500 cP.

In another embodiment, the fabric softening composition further includes an aqueous carrier; a fragrance; a thickener; a preservative; and a colorant.

In another embodiment, the fabric care composition is in the form of a liquid and has a viscosity from about 30 to about 500 cP, e.g., about 30 to about 300 cP or about 30 to about 100 cP.

In another embodiment, the fabric softening agent mixture is a stable and water-soluble liquid mixture.

In another embodiment, the amount of esterquat and polyquaternium-7 in the fabric softening composition is based on the following Formula I: Y=−0.0043X²+0.0649X−0.0037, wherein X is the amount of esterquat to be replaced and Y is the amount of polyquaternium-7.

The foregoing and/or other aspects and utilities embodied in the present disclosure may also be achieved by providing a method of creating a reduced-esterquat fabric care composition, including determining the amount of esterquat in a known fabric care composition; modifying the known fabric care composition by substituting x weight % esterquat with x weight % polyquaternium-7; and creating a reduced-esterquat fabric care composition based on the modified fabric care composition, wherein the reduced-esterquat fabric care composition has at least an equivalent performance to the known fabric care composition with respect to at least one of softness, ease of ironing, and wrinkle reduction.

In another embodiment, the reduced-esterquat fabric care composition includes no surfactants other that the esterquat.

In another embodiment, the reduced-esterquat fabric care composition includes no other fabric softening agents other that the esterquat and the polyquaternium-7.

In another embodiment, the reduced-esterquat fabric care composition has a viscosity from 50 to 300 cP.

In another embodiment, the reduced-esterquat fabric care composition further includes an aqueous carrier; from 0.3 weight % to 3 weight % fragrance; 0.001 weight % or more thickener; and 0.2 weight % or less preservative.

A list of non-limiting, exemplary embodiments in accordance with aspects of the invention is provided below.

In accordance with embodiment 1, provided is a liquid fabric care composition comprising:
dialkylester triethanol ammonium methyl sulfate;
a silicone or a copolymer of acrylamide and diallyldimethylammonium chloride; and
greater than about 50 wt. % water,
for use in reducing or preventing the adhesion of pet hair to a fabric.

In accordance with embodiment 2, provided is a liquid fabric care composition according to the embodiment 1, comprising from about 0.5 wt. % to about 5 wt. % of a dialkylester triethanol ammonium methyl sulfate.

In accordance with embodiment 3, provided is a liquid fabric care composition according to embodiments 1 or 2, comprising from about 1 wt. % to about 4 wt. % of a dialkylester triethanol ammonium methyl sulfate.

In accordance with embodiment 4, provided is a liquid fabric care composition according to any foregoing embodiment, comprising from about 3.0 wt. % to about 3.5 wt. % of a dialkylester triethanol ammonium methyl sulfate.

In accordance with embodiment 5, provided is a liquid fabric care composition according to any foregoing embodiment, comprising from about 0.1 wt. % to about 1 wt. % of a silicone.

In accordance with embodiment 6, provided is a liquid fabric care composition according to any foregoing claim, comprising from about 0.25 wt. % to about 0.5 wt. % of a silicone.

In accordance with embodiment 7, provided is a liquid fabric care composition according to any foregoing embodiment, wherein the copolymer of acrylamide and diallyldimethylammonium chloride is modified.

In accordance with embodiment 8, provided is a liquid fabric care composition according to embodiment 7, wherein the copolymer of acrylamide and diallyldimethylammonium chloride is modified with a linear or branched hydrocarbon.

In accordance with embodiment 9, provided is a liquid fabric care composition according to any foregoing embodiment, comprising from about 0.01 wt. % to about 2 wt. % of a copolymer of acrylamide and diallyldimethylammonium chloride.

In accordance with embodiment 10, provided is a liquid fabric care composition according to any foregoing embodiment, comprising from about 0.05 wt. % to about 1.5 wt. % of a copolymer of acrylamide and diallyldimethylammonium chloride.

In accordance with embodiment 11, provided is a liquid fabric care composition according to any foregoing embodiment, comprising from about 0.1 wt. % to about 1.0 wt. % of a copolymer of acrylamide and diallyldimethylammonium chloride.

In accordance with embodiment 12, provided is a liquid fabric care composition according to any foregoing claim, comprising from about 0.2 wt. % to about 0.5 wt. % of a copolymer of acrylamide and diallyldimethylammonium chloride.

In accordance with embodiment 13, provided is a liquid fabric care composition according to any foregoing embodiment, comprising about 0.3 wt. % of a copolymer of acrylamide and diallyldimethylammonium chloride.

In accordance with embodiment 14, provided is a liquid fabric care composition according to any foregoing embodiment, further comprising a thickening system comprising an acrylate copolymer.

In accordance with embodiment 15, provided is a liquid fabric care composition according to embodiment 14, wherein the thickening system comprises from about 0.01 wt. % to about 2 wt. % of an acrylate copolymer.

In accordance with embodiment 16, provided is a liquid fabric care composition according to embodiments 14 or 15, wherein the thickening system comprises from about 0.05 wt. % to about 1.5 wt. % of an acrylate copolymer.

In accordance with embodiment 17, provided is a liquid fabric care composition according to any one of embodiments 14 to 16, wherein the thickening system comprises from about 0.1 wt. % to about 1.0 wt. % of an acrylate copolymer.

In accordance with embodiment 18, provided is a liquid fabric care composition according to any one of embodiments 14 to 17, wherein the thickening system comprises from about 0.2 wt. % to about 0.5 wt. % of an acrylate copolymer.

In accordance with embodiment 19, provided is a liquid fabric care composition according to any one of embodiments 14 to 18, wherein the thickening system comprises from about 0.3 wt. % to about 0.4 wt. % of an acrylate copolymer.

In accordance with embodiment 20, provided is a liquid fabric care composition according to any foregoing embodiment, comprising from about 50 wt. % to about 99 wt. %, water.

In accordance with embodiment 21, provided is a liquid fabric care composition according to any foregoing embodiment, comprising from about 75 wt. % to about 98 wt. %, water.

In accordance with embodiment 22, provided is a liquid fabric care composition according to any foregoing embodiment, comprising from about 85 wt. % to about 97 wt. %, water.

In accordance with embodiment 23, provided is a liquid fabric care composition according to any foregoing embodiment, comprising from about 95 wt. % to about 96 wt. %, water.

In accordance with embodiment 24, provided is a liquid fabric care composition according to any foregoing embodiment, wherein the liquid fabric care composition reduces the electrostatic force between pet hair and a fabric.

In accordance with embodiment 25, provided is a liquid fabric care composition according to any foregoing embodiment, wherein the liquid fabric care composition provides a Hair Adhesion Benefit Score of less than 50, optionally less than 49, less than 48, less than 47, less than 46, less than 45, less than 44, less than 43, less than 42, less than 41, less than 40, less than 39, less than 38, less than 37, less than 36, less than 35, less than 34, less than 33, less than 32, less than 31, less than 30, less than 29, less than 28, less than 27, less than 26, less than 25, less than 24, less than 23, less than 22, less than 21, or less than 20.

In accordance with embodiment 26, provided is a liquid fabric care composition comprising:
water;
a dialkylester triethanol ammonium methyl sulfate; and
an effective amount of an anti-adhesion component comprising:
a silicone, and/or
a copolymer of acrylamide and diallyldimethylammonium chloride,
wherein the anti-adhesion component is present in an amount effective to reduce the adhesion of pet hair to a fabric.

In accordance with embodiment 27, provided is a liquid fabric care composition for use in reducing or preventing the adhesion of pet hair to a fabric. comprising:
dialkylester triethanol ammonium methyl sulfate;
a silicone or a copolymer of acrylamide and diallyldimethylammonium chloride; and
greater than about 50 wt. % water.

In accordance with embodiment 28, provided is a liquid fabric care composition comprising:
dialkylester triethanol ammonium methyl sulfate;
a silicone or a copolymer of acrylamide and diallyldimethylammonium chloride; and
greater than about 50 wt. % water,
wherein the composition reduces or prevents the adhesion of pet hair to a fabric.

In accordance with embodiment 29, provided is a use of a composition described herein for reducing or preventing the adhesion of pet hair to a fabric.

In accordance with embodiment 30, provided is the use according to embodiment 29, wherein the composition is a liquid composition.

In accordance with embodiment 31, provided is the use according to embodiments 29 or 30, wherein the composition comprises:
water;
a dialkylester triethanol ammonium methyl sulfate; and
an effective amount of an anti-adhesion component comprising:
a silicone, and/or
a copolymer of acrylamide and diallyldimethylammonium chloride.

In accordance with embodiment 32, provided is a method of reducing or preventing the adhesion of pet hair to a fabric, the method comprising:
applying to a fabric a liquid composition comprising:
water;
a dialkylester triethanol ammonium methyl sulfate; and
an effective amount of an anti-adhesion component comprising:
a silicone; and/or
a copolymer of acrylamide and diallyldimethylammonium chloride,
wherein the anti-adhesion component is present in an amount effective to reduce the adhesion of pet hair to a fabric.

### BRIEF DESCRIPTION OF THE DRAWINGS

FIG. 1 depicts area for analysis of pet hair adherence, whereby the contact between pet hair and the fabric was restricted to the area inside the circle.

FIG. 2 depicts the various types of fabric used in the evaluation of pet hair adherence.

FIG. 3 depicts the results of the 2 AFCM comparative evaluations.

FIG. 4 depicts a main effects plot for pet hair adhesion.

FIG. 5 depicts the results of a 2AFCM evaluation of pet hair adhesion, which compared an exemplary composition of the present invention and a comparative composition.

FIG. 6A depicts hair adhesion benefit scores for pet hair adhesion of dog hair.

FIG. 6B depicts hair adhesion benefit scores for pet hair adhesion of cat hair.

FIG. 7 depicts the results of a 2AFCM comparison of two exemplary compositions of the present invention.

FIG. 8 depicts static charge dissipation plots for an exemplary composition of the present invention and a comparative composition/treatment in two different environmental conditions.

### DETAILED DESCRIPTION

Reference will now be made in detail to the various embodiments in the present disclosure. The embodiments are described below to provide a more complete understanding of the components, processes, compositions, and apparatuses disclosed herein. Any examples given are intended to be illustrative, and not restrictive. However, it will be apparent to one of ordinary skill in the art that the invention may be practiced without these specific details. In other instances, well-known methods, procedures, and components have not been described in detail so as not to unnecessarily obscure aspects of the embodiments.

Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments may be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes embodiments containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.”

It will also be understood that, although the terms first, second, etc. may be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” may be construed to mean “when” or “upon” or “in response to determining” or “in response to detecting,” depending on the context.

All physical properties that are defined hereinafter are measured at 20° to 25º Celsius unless otherwise specified.

When referring to any numerical range of values herein, such ranges are understood to include each and every number and/or fraction between the stated range minimum and maximum, as well as the endpoints. For example, a range of 0.5-6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith.

Unless otherwise specified, all percentages and amounts expressed herein and elsewhere in the specification should be understood to refer to percentages by weight. The amounts given are based on the active weight of the material. Unless otherwise specified, all component or composition amounts are in reference to the active amount of that component or composition, and exclude impurities or by-products, which may be present in commercially available sources.

With regard to procedures, methods, techniques, and workflows that are in accordance with some embodiments, some operations in the procedures, methods, techniques, and workflows disclosed herein may be combined and/or the order of some operations may be changed.

A fabric care composition as disclosed herein includes a fabric softening agent and an anti-adhesion component comprising a co-softening agent. The fabric care compositions may be in liquid form and may include an aqueous carrier.

The fabric care composition includes one or more fabric softening agents. In certain embodiments, the fabric softening agent is a cationic softener selected from among esterquats, imidazolinium quats, difatty diamide ammonium methyl sulfate, ditallow dimethyl ammonium chloride, and mixtures thereof. For example, in certain embodiments, the fabric softening agent is an esterquat of the following formula:

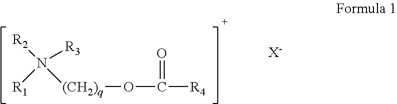

wherein R₄ is an aliphatic hydrocarbon group having from 8 to 22 carbon atoms, R₂ and R₃ represent (CH₂)ₛ—R₅, where R₅ is an alkoxy carbonyl group containing from 8 to 22 carbon atoms, benzyl, phenyl, C₁-C₄ alkyl substituted phenyl, OH or H; R₁ is (CH₂)ₜ—R₆, where R₆ is benzyl, phenyl, C₁-C₄ alkyl substituted phenyl, OH or H; q, s, and t, each independently, are an integer from 1 to 3; and X⁻ is a softener compatible anion.

The esterquat may be produced by reacting about 1.65 (1.5 to 1.75) moles of fatty acid methyl ester with one mole of alkanol amine followed by quaternization with dimethyl sulfate (further details on this preparation method are disclosed in U.S. Pat. No. 3,915,867, which is incorporated herein in its entirety for all purposes). Using this ratio controls the amount of each of monoesterquat, diesterquat, and triesterquat in the composition. In certain embodiments, the alkanol amine comprises triethanolamine. In certain embodiments, it is desirable to increase the amount of diesterquat and minimize the amount of triesterquat to increase the softening capabilities of the composition. By selecting a ratio of about 1.65, the triesterquat can be minimized while increasing the monoesterquat. For example, by producing the esterquat by reacting fatty acid methyl with alkanol amine in a molar ratio of about 1.5:1 to about 1.8:1, about 1.6:1 to about 1.7:1, or about 1.65:1, the triesterquat can be minimized while increasing the monoesterquat.

Monoesterquat is more soluble in water than triesterquat. Depending on the AI, more or less monoesterquat is desired. At higher AI levels (usually at least 7%), more monoesterquat as compared to triesterquat is desired so that the esterquat is more soluble in the water so that the esterquat can be delivered to fabric during use. At lower AI levels (usually up to 3%), less monoesterquat is desired because during use, it is desired for the esterquat to leave solution and deposit on fabric to effect fabric softening. Depending on the AI, the amount of monoesterquat and triesterquat are adjusted to balance solubility and delivery of the esterquat.

In certain embodiments, the reaction products are 50-65 weight % diesterquat, 20-40 weight % monoester, and 25 weight % or less trimester. In other embodiments, the amount of diesterquat is 52-60, 53-58, or 53-55 weight %. In other embodiments, the amount of monoesterquat is 30-40 or 35-40 weight %. In other embodiments, the amount of triesterquat is 1-12 or 8-11 weight %.

The percentages, by weight, of mono, di, and tri esterquats, as described above are determined by a quantitative analytical method. The percentages, by weight, of the mono, di and tri esterquats measured on dried samples are normalized on the basis of 100%. The normalization is required due to the presence of 10% to 15%, by weight, of non-quaternized species, such as ester amines and free fatty acids. Accordingly, the normalized weight percentages refer to the pure esterquat component of the raw material. In other words, for the weight % of each of monoesterquat, diesterquat, and triesterquat, the weight % is based on the total amount of monoesterquat, diesterquat, and triesterquat in the composition.

In certain embodiments, the percentage of saturated fatty acids based on the total weight of fatty acids is 45 to 75%. Esterquat compositions using this percentage of saturated fatty acids do not suffer from the processing drawbacks of 100% saturated materials. When used in fabric softening, these compositions provide good consumer perceived fabric softness while retaining good fragrance delivery. In other embodiments, the amount is at least 50, 55, 60, 65 or 70 up to 75%. In other embodiments, the amount is no more than 70, 65, 60, 55, or 50 down to 45%. In other embodiments, the amount is 50 to 70%, 55 to 65%, or 57.5 to 67.5%. For instance, the percentage saturated fatty acids based on the total weight of fatty acids may be from about 45 to about 75%, about 45 to about 70%, about 45 to about 65%, about 45 to about 60%, about 45 to about 55%; from about 50 to about 75%, about 50 to about 70%, about 50 to about 65%, about 50 to about 60%; from about 55 to about 75%, about 55 to about 70%, about 55 to about 65%; from about 60 to about 75%, about 60 to about 70%, about 65 to 75%, or any range or subrange thereof.

In one embodiment, the percentage of the fatty acid chains that are saturated is about 62.5% by weight of the fatty acid. In this embodiment, this can be obtained from a 50:50 ratio of hard:soft fatty acid. By hard, it is meant that the fatty acid is close to full hydrogenation. In certain embodiments, a fully hydrogenated fatty acid has an iodine value of 10 or less. By soft, it is meant that the fatty acid is no more than partially hydrogenated. In certain embodiments, a no more than partially hydrogenated fatty acid has an iodine value of at least 40. In certain embodiments, a partially hydrogenated fatty acid has an iodine value of 40 to 55. The iodine value can be measured by ASTM D5554-95 (2006). In certain embodiments, a ratio of hard fatty acid to soft fatty acid is 70:30 to 40:60. In other embodiments, the ratio is 60:40 to 40:60 or 55:45 to 45:55. In one embodiment, the ratio is about 50:50. Because in these specific embodiments, each of the hard fatty acid and soft fatty acid cover ranges for different levels of saturation (hydrogenation), the actual percentage of fatty acids that are fully saturated can vary. In certain embodiments, soft tallow contains approximately 47% saturated chains by weight.

The percentage of saturated fatty acids can be achieved by using a mixture of fatty acids to make the esterquat, or the percentage can be achieved by blending esterquats with different amounts of saturated fatty acids.

The fatty acids can be any fatty acid that is used for manufacturing esterquats for fabric softening. Examples of fatty acids include, but are not limited to, coconut oil, palm oil, tallow, rape oil, fish oil, or chemically synthesized fatty acids. In certain embodiments, the fatty acid is tallow. For example, the esterquat may be a hydrogenated tallow esterquat, such as TETRANYL L1/90, available commercially from Kao chemicals, Tokyo, Japan.

While the esterquat can be provided in solid form, it is usually present in a solvent in liquid form. In solid form, the esterquat can be delivered from a dryer sheet in the laundry. In certain embodiments, the solvent comprises water.

AI refers to the active weight of the combined amounts for monoesterquat, diesterquat, and triesterquat. Delivered AI refers to the mass (in grams) of esterquat used in a laundry load. A load is 3.5 kilograms of fabric in weight. As the size of a load changes, for example using a smaller or larger size load in a washing machine, the delivered AI adjusts proportionally. In certain embodiments, the delivered AI is 2.8 to 8 grams per load. In other embodiments, the delivered AI is 2.8 to 7, 2.8 to 6, 2.8 to 5, 3 to 8, 3 to 7, 3 to 6, 3 to 5, 4 to 8, 4 to 7, 4 to 6, or 4 to 5 grams per load.

In one embodiment, the fabric care composition includes 20 weight % or less fabric softening agent, based on a total weight of the fabric care composition. In certain embodiments, the fabric care composition includes 15 weight % or less, 10 weight % or less, or 5 weight % or less fabric softening agent. In other embodiments, the fabric care composition includes 3 weight % or less, 2 weight % or less, or 1 weight % or less fabric softening agent. For example, the fabric care composition may include 4 weight % or less quaternized triethanolamine diester. Typically, when included, the fabric care compositions include at least 0.5 weight % fabric softening agent. For example, the amount of fabric softening agent in the fabric care composition may be from about 0.5 to about 20 weight %, about 0.5 to about 15 weight %, about 0.5 to about 10 weight %, about 0.5 to about 5 weight %, about 0.5 to about 3 weight %, about 0.5 to about 2 weight %, about 0.5 to about 1 weight %; from about 1 to about 20 weight %, about 1 to about 15 weight %, about 1 to about 10 weight %, about 1 to about 5 weight %, about 1 to about 3 weight %, about 1 to about 2 weight %; from about 1.5 to about 20 weight %, about 1.5 to about 15 weight %, about 1.5 to about 10 weight %, about 1.5 to about 5 weight %, about 1.5 to about 3 weight %, about 1.5 to about 2 weight %; from about 2 to about 20 weight %, about 2 to about 15 weight %, about 2 to about 10 weight %, about 2 to about 5 weight %, about 2 to about 3 weight %; from about 3 to about 20 weight %, about 3 to about 15 weight %, about 3 to about 10 weight %, about 3 to about 5 weight %; from about 5 to about 20 weight %, about 5 to about 15 weight %, about 5 to about 10 weight %, or any range or subrange thereof, based on the total weight of the fabric care composition.

The fabric care composition also includes an anti-adhesion component. The anti-adhesion component may be selected from one or more co-softening agent, such as those disclosed herein. In some embodiments, the anti-adhesion component consists of co-softening agents, such as those described herein. The anti-adhesion component and/or co-softening agent may be a polyquaternium polymer. According to one embodiment, the co-softening agent is a stable, water-soluble, and liquid polyquaternium polymer. For example, the anti-adhesion component and/or co-softening agent may be polyquaternium-7. Polyquaternium-7 (PQ7) is the copolymer of acrylamide and diallyldimethylammonium chloride, and is usually represented with the following chemical formula: (C₈H₁₆ClN)ₙ(C₃H₅NO)ₘ. Polyquaternium-7 is available commercially as NOVERITE 300 from Lubrizol Corporation, Wickliffe, Ohio, and as FLOCARE LS737, from SNF Floerger, Andrézieux, France.

Some embodiments of the present invention provide a liquid fabric care composition comprising: dialkylester triethanol ammonium methyl sulfate; a silicone or a copolymer of acrylamide and diallyldimethylammonium chloride; and greater than about 50 wt. % water; for use in reducing or preventing the adhesion of pet hair to a fabric. Some embodiments provide a liquid fabric care composition comprising from about 0.5 wt. % to about 5 wt. % of a dialkylester triethanol ammonium methyl sulfate. Other embodiments provide a liquid fabric care composition comprising from about 1 wt. % to about 4 wt. % of a dialkylester triethanol ammonium methyl sulfate. Yet other embodiments provide a liquid fabric care composition comprising from about 3.0 wt. % to about 3.5 wt. % of a dialkylester triethanol ammonium methyl sulfate.

Some embodiments of the present invention provide a liquid fabric care composition comprising from about 0.1 wt. % to about 1 wt. % of a silicone. In some embodiments, the liquid fabric care composition comprises from about 0.25 wt. % to about 0.5 wt. % of a silicone.

The one or more silicones may be chosen from amino silicones (e.g., amodimethicone), non-amino silicones (e.g., dimethicone), and combinations thereof. The term “amino silicone” may refer to any silicone comprising at least one primary, secondary or tertiary amine or a quaternary ammonium group (i.e., a quaternized group).

Non-limiting examples of silicones include dimethiconol, dimethicone, and a mixture thereof. Non-limiting examples of amino silicone oils include amodimethicone, aminoethylaminopropyl dimethicone, aminopropyl dimethicone, polysiloxanes, trimethylsilylamodimethicone, or a combination of two or more thereof. Further examples of silicones include silicone quaternium 80, silicone quaternium-1, silicone quaternium-2, silicone quaternium-2 panthenol succinate, silicone quaternium-3, silicone quaternium-4, silicone quaternium-5, silicone quaternium-6, silicone quaternium-7, silicone quaternium-8, silicone quaternium-9, silicone quaternium-10, silicone quaternium-11, silicone quaternium-12, silicone quaternium-15, silicone quaternium-16, silicone quaternium-16/glycidoxy dimethicone crosspolymer, silicone quaternium-17, silicone quaternium-18, silicone quaternium-20, silicone quaternium-21, or a combination of two or more thereof.

The weight-average molecular weight (Mw) of the silicone ranges preferably from 2,000 to 1,000,000, e.g., from 3,500 to 200,000. In some cases, the weight-average molecular weight (Mw) of the silicone ranges preferably from 2,000 to 200,000, e.g., 5,000 to 100,000 or 10,000 to 50,000.

In some embodiments, the copolymer of acrylamide and diallyldimethylammonium chloride is modified. In other embodiments, the copolymer of acrylamide and diallyldimethylammonium chloride is modified with a linear or branched hydrocarbon. In some embodiment, the liquid fabric care composition comprises from about 0.01 wt. % to about 2 wt. % of a copolymer of acrylamide and diallyldimethylammonium chloride. In other embodiments, the liquid fabric care composition according to any foregoing claim, comprising from about 0.05 wt. % to about 1.5 wt. % of a copolymer of acrylamide and diallyldimethylammonium chloride. Still further embodiments provide liquid fabric care compositions comprising from about 0.1 wt. % to about 1.0 wt. % of a copolymer of acrylamide and diallyldimethylammonium chloride. Certain embodiments provide a liquid fabric care composition comprising from about 0.2 wt. % to about 0.5 wt. % of a copolymer of acrylamide and diallyldimethylammonium chloride. Other embodiments provide a liquid fabric care composition according to any foregoing claim, comprising about 0.3 wt. %, or about 0.35 wt. % or about 0.4 wt. % of a copolymer of acrylamide and diallyldimethylammonium chloride.

Other embodiments of the present invention provide a liquid fabric care composition further comprising a thickening system comprising an acrylate copolymer. In some embodiments, the thickening system comprises from about 0.01 wt. % to about 2 wt. % of an acrylate copolymer. In further embodiments, the thickening system comprises from about 0.05 wt. % to about 1.5 wt. % of an acrylate copolymer. Yet other embodiments provide a thickening system comprising from about 0.1 wt. % to about 1.0 wt. % of an acrylate copolymer. While other embodiments provide a thickening system comprising from about 0.2 wt. % to about 0.5 wt. % of an acrylate copolymer. Still further embodiments provide a thickening system comprising from about 0.3 wt. % to about 0.4 wt. % of an acrylate copolymer.

In some embodiments, the liquid fabric care compositions of the present invention comprise from about 50 wt. % to about 99 wt. %, water. In some embodiments, the liquid fabric care compositions of the present invention comprise from about 75 wt. % to about 98 wt. %, water.

In some embodiments, the liquid fabric care compositions of the present invention comprise from about 85 wt. % to about 97 wt. %, water. In some embodiments, the liquid fabric care compositions of the present invention comprise from about 95 wt. % to about 96 wt. %, water.

In some embodiments, liquid fabric care compositions described herein reduce the electrostatic force between pet hair and a fabric.

In other embodiments, the liquid fabric care composition provides a Hair Adhesion Benefit Score of less than 50, optionally less than 49, less than 48, less than 47, less than 46, less than 45, less than 44, less than 43, less than 42, less than 41, less than 40, less than 39, less than 38, less than 37, less than 36, less than 35, less than 34, less than 33, less than 32, less than 31, less than 30, less than 29, less than 28, less than 27, less than 26, less than 25, less than 24, less than 23, less than 22, less than 21, or less than 20. The Hair Adhesion Benefit Score may be assessed as described in Example 2. For example, the hair adhesion benefit score may be assessed by visually evaluating two fabric samples having equivalent amounts of hair, where one was washed with a detergent and a fabric care composition disclosed herein and the other fabric sample is washed under the same conditions but with only the detergent, and where the visual evaluation comprises a plurality of evaluator (e.g., 4, 6, 8, 10, 20, 30 or more) giving the fabric sample a one value (if less hair) or a two value (if more hair) than the fabric sample washed with detergent only and then averaging the number to determine a hair adhesion benefit score achieved by the fabric care composition.

Some embodiments of the present invention provide a liquid fabric care composition comprising: water; a dialkylester triethanol ammonium methyl sulfate; and an effective amount of an anti-adhesion component comprising: a silicone; and/or a copolymer of acrylamide and diallyldimethylammonium chloride; wherein the anti-adhesion component is present in an amount effective to reduce the adhesion of pet hair to a fabric.

Other embodiments of the present invention provide a liquid fabric care composition for use in reducing or preventing the adhesion of pet hair to a fabric. comprising: dialkylester triethanol ammonium methyl sulfate; a silicone, or a copolymer of acrylamide and diallyldimethylammonium chloride; and greater than about 50 wt. % water. Yet other embodiments of the present invention provide a liquid fabric care composition comprising: dialkylester triethanol ammonium methyl sulfate; a silicone; or a copolymer of acrylamide and diallyldimethylammonium chloride; and greater than about 50 wt. % water; wherein the composition reduces or prevents the adhesion of pet hair to a fabric.

Still further embodiments of the present invention provide for the use of a composition described herein for reducing or preventing the adhesion of pet hair to a fabric. In some embodiments, the composition is a liquid composition comprising: water; a dialkylester triethanol ammonium methyl sulfate; and an effective amount of an anti-adhesion component comprising: a silicone; and/or a copolymer of acrylamide and diallyldimethylammonium chloride.

Other embodiments of the present invention provide a method of reducing/preventing the adhesion of pet hair to a fabric, the method comprising: applying to a fabric any one of the compositions described herein. Yet other embodiments of the present invention provide a method of reducing/preventing the adhesion of pet hair to a fabric, the method comprising: applying to a fabric a liquid composition comprising: water; a dialkylester triethanol ammonium methyl sulfate; and an effective amount of an anti-adhesion component comprising: a silicone; and/or a copolymer of acrylamide and diallyldimethylammonium chloride; wherein the anti-adhesion component is present in an amount effective to reduce the adhesion of pet hair to a fabric.

As described herein, the inventors have surprisingly discovered that, compared to other polyquaternium polymers, PQ7 provides considerable advantages. For example, PQ7 is typically provided in a liquid dispersion. This facilitates its use in continuous manufacturing systems. PQ7 also form stable mixtures compared with mixtures using powder or solid polyquaternium polymers. The fabric conditioning performance of PQ7 was also unexpected in view of the low amounts of this material used, and such performance cannot be realized by other polyquaternium polymers (e.g., Polyquaternium 67, Polyquaternium 5, etc.). The use of PQ7 also displayed improved fragrance delivery in some important key touch points for consumers. Additional polyquaternium polymers that may be included or in some instances excluded from the fabric care composition include hydroxylethyl cellulose dimethyl diallylammonium chloride copolymer (PQ-4), a terpolymer of acrylic acid, methacrylamide-propyl trimethylammonium chloride, and methyl acrylate (PQ-47).

In one embodiment, the fabric care composition includes up to 0.30 weight % of an anti-adhesion component (e.g., polyquaternium-7), based on the total weight of the fabric care composition. In other embodiments, the fabric care composition includes from 0.05 weight % to 0.25 weight % of an anti-adhesion component or from 0.05 weight % to 0.20 weight % of an anti-adhesion component. For example, the fabric care composition may include from 0.5 weight % to 0.25 weight % polyquaternium-7.

In another embodiment, the amount of anti-adhesion component and/or co-softening agent in the fabric care composition may be determined by the amount of fabric softening agent to be replaced. That is, the inventors have surprisingly discovered a method of reducing the fabric softening agent (e.g., esterquat) content of a known fabric care composition with established performance characteristics (e.g., softness, fragrance delivery, ease of ironing, wrinkly reducing, dispersion, etc.) by substitution with an anti-adhesion component and/or co-softening agent (e.g., PQ7) while maintaining similar or superior performance characteristics. For example, the amount of anti-adhesion component and/or co-softening agent in the fabric care composition may be determined by the following formula.

$$Y = - 0.0043 {X}^{2} + 0.0649 X - 0.0037 \qquad Formula 2$$

wherein X is the amount of fabric softening agent (e.g., esterquat) to be replaced, and Y is the amount of anti-adhesion component and/or co-softening agent (e.g., PQ7) needed to provide a similar performance to the X amount of fabric softening agent.

Formula 2 can be used to reduce the amount of fabric softening agent of a known fabric softening agent-containing fabric care composition while maintaining a comparable performance. For example, under Formula 2, 1 weight % of fabric softening agent (e.g., esterquat) may be replaced with about 0.06% of anti-adhesion component (e.g., polyquaternium-7). That is, a known esterquat-containing fabric care composition may be modified to include 1 weight % less esterquat for each 0.06 weight % polyquaternium-7 added. In another embodiment, 2 weight % of esterquat may be replaced with about 0.11% weight % polyquaternium-7, or 3 weight % of esterquat may be replaced with about 0.15% weight % polyquaternium-7.

In some embodiments, the combination of the fabric softening agent (e.g., esterquat) and anti-adhesion component (e.g., polyquaternium-7) form a fabric softening agent mix. The fabric softening agent mix may form a stable liquid mixture that does not separate when stored at room temperature. The fabric softening agent mix may form a water-soluble mixture.

The fabric care composition may be substantially free of fabric softeners other than the fabric softening agent and the anti-adhesion component. For example, in some embodiments, other than esterquat, the fabric care composition is substantially free of any other fabric softening agents. In some embodiments, other than polyquaternium-7, the fabric care composition is substantially free of any other anti-adhesion component and/or co-softening agents. In some embodiments, other than esterquat and polyquaternium-7, the fabric care composition is substantially free of any other fabric softening agents and co-softening agents, respectively.

Esterquats may be considered a cationic surfactant. In some embodiments, the fabric care composition is substantially free of surfactants other than the fabric softening agent. For example, the fabric care composition is substantially free of surfactants other than esterquat. In some embodiments, the fabric care composition is substantially free of detersive surfactants. In another embodiment, the fabric care composition is substantially free of anionic surfactants.

The fabric care composition may include an aqueous carrier. For example, the fabric care composition may include water as the carrier. In certain embodiments, the amount of water is at least 30%, 40%, 50%, 60%, 70%, 80%, or 85% by weight of the composition. In one embodiment, the fabric care composition includes 25 weight % or more water, based on the total weight of the fabric care composition. In other embodiments, the fabric care composition includes 50 weight % or more water or 75 weight % or more water, based on the total weight of the fabric care composition.

In some embodiments, the fabric care composition may be a low-water or “concentrated” formulation intended to be diluted before use. In such embodiments, the fabric care composition includes lower amounts of the aqueous carrier. In certain embodiments, the amount of water is no more than 50%, 40%, 30%, 20%, 15%, or 10% by weight of the composition. For example, the fabric care composition may include 50 weight % or less water or 30 weight % or less water, based on the total weight of the fabric care composition.

The fabric care composition may also include other components commonly used in fabric care compositions in minor amounts to enhance either the appearance or performance of the fabric care compositions. For example, the fabric care composition may include thickeners, fragrances, preservatives, colorants such as dyes or pigments, bluing agents, germicides, and opacifying agents.

In some embodiments, the fabric care composition must be easily pourable by an end user. Accordingly, the viscosity of the fabric care composition should not exceed 500 centipois (cP) for ready-to-use fabric care compositions, preferably not more than 250 cP, and 10,000 cP for fabric care composition intended for dilution before use. In one embodiment, the fabric care composition has a pour viscosity from 30 to 500 cP, or from 50 to 200 cP. Unless otherwise specified, viscosity is measured at 25° C. using a Brookfield RVTD Digital Viscometer with Spindle #2 at 50 rpm.

In order to adjust the viscosity, the fabric care composition may include one or more thickeners. The one or more thickeners may include cationic polymeric thickeners that are water soluble and with a high molecular weight. For example, the thickener can be a cross-linked cationic polymer such as FLOSOFT DP200. FLOSOFT DP200 is commercially available from SNF Floerger, and is described in U.S. Pat. No. 6,864,223 to Smith et al. FLOSOFT DP200 is a water soluble cross-linked cationic polymer derived from the polymerization of from 5 to 100 mole percent of cationic vinyl addition monomer, from 0 to 95 mole percent of acrylamide, and from 70 to 300 ppm of a difunctional vinyl addition monomer cross-linking agent.

Other suitable thickener are water-soluble cross-linked cationic vinyl polymers which are cross-linked using a cross-linking agent of a difunctional vinyl addition monomer at a level of from 70 to 300 ppm, preferably from 75 to 200 ppm, and most preferably of from 80 to 150 ppm. These polymers are further described in U.S. Pat. No. 4,806,345, and other polymers that may be utilized are disclosed in WO 90/12862. Generally, such polymers are prepared as water-in-oil emulsions, wherein the cross-linked polymers are dispersed in mineral oil, which may contain surfactants. During finished product making, in contact with the water phase, the emulsion inverts, allowing the water soluble polymer to swell. The most preferred thickener may be a cross-linked copolymer of a quaternary ammonium acrylate or methacrylate in combination with an acrylamide comonomer. The thickener may provide the fabric care composition long term stability upon storage and allows the presence of relatively high levels of electrolytes without affecting the composition stability. Additionally, the fabric care compositions remain stable when shear is applied thereto. In certain embodiments, the amount of this thickening polymer is at least 0.001 weight %. In other embodiments, the amount is 0.001 to 0.35 weight %.

In one embodiment, the fabric care composition includes 0.5 weight % or less thickener, based on the total weight of the fabric care composition. In other embodiments, the fabric care composition includes 0.1 weight % or less thickener or 0.05 weight % or less thickener, based on the total weight of the fabric care composition.

The fabric care composition may include one or more fragrances, fragrance oils, or perfumes. As used herein, the term “fragrance” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced odoriferous substances. As used herein, fragrance, or perfume, refers to odoriferous materials that are able to provide a desirable fragrance to fabrics, and encompasses conventional materials commonly used in detergent compositions to provide a pleasing fragrance and/or to counteract a malodor. The fragrances are generally in the liquid state at ambient temperature, although solid fragrances can also be used. Fragrance materials include, but are not limited to, such materials as aldehydes, ketones, esters and the like that are conventionally employed to impart a pleasing fragrance to laundry compositions. Naturally occurring plant and animal oils are also commonly used as components of fragrances.

The fabric care composition may include free fragrances, encapsulated fragrances, or a mixture of both.

In other embodiments, the fabric care composition may be provided as a fragrance-free composition. The amount of fragrance can be any desired amount depending on the preference of the user. In certain embodiments, the total amount of fragrance is from 0.3 weight % to 3 weight % based on the total weight of the fabric care composition. The fragrance can be in free form, encapsulated, or both.

The fabric care composition may include one or more preservatives. The one or more preservatives may include one or more organic acids, such as lactic acid and/or phosphonic acid. For example, the fabric care composition may include combinations of food grade lactic acid and amino trimethyl phosphonic acid. In certain embodiments, the fabric care composition may also include isothiazolinones as preservatives. For example, the one or more preservatives may include a (OIT/MIT/CIT) isothiazolinone mixture. Suitable isothiazolinone preservatives include the isothiazolinones sold under the trademark KATHON DP3 and available from Rohm & Haas.

In one embodiment, the fabric care composition includes 0.2 weight % or less preservative, based on the total weight of the fabric care composition. In other embodiments, the fabric care composition includes 0.15 weight % or less preservative or 0.10 weight % or less preservative, based on the total weight of the fabric care composition.

### EXAMPLES

### Example 1

Table 1 (below) describes exemplary compositions (Example Compositions 1-5) of the present invention, which can be prepared by conventional methods known to those skilled in the art.

TABLE 1

| | Ex. 1 | Ex. 2 | Ex. 3 | Ex. 4 | Ex. 5 |
|---|---|---|---|---|---|
| Ingredient | Wt. % | | | | |
| Water | 95.2065 | 95.2565 | 95.1123 | 95.1543 | 94.8043 |
| Fragrance | 0.79 | 0.74 | 0.84 | 0.84 | 0.84 |
| Lactic Acid (88%) | 0.0625 | 0.0625 | 0.0625 | 0.0625 | 0.0625 |
| Preservative | 0.02 | 0.02 | 0.02 | 0.02 | 0.02 |
| Dialkylester triethanol | 3.271 | 3.271 | 3.271 | 3.271 | 3.271 |
| ammonium methyl | | | | | |
| sulfate | | | | | |
| Cationic Acrylate | 0.35 | 0.35 | 0.35 | 0.35 | 0.35 |
| Thickener | | | | | |
| Polydimethylsiloxane, | 0.3 | 0.3 | — | 0.3 | 0.35 |
| modified, emulsion | | | | | |
| Polyquaternium 7 | — | — | 0.342 | — | 0.3 |
| modified | | | | | |

### Example 2

To evaluate the formula under the most challenging conditions, a heterogeneous sample of pet hair is obtained from a dog hair cut shop. The sample is composed of hair samples from different dog species, without further treatment applied after receiving the samples, this implies the use of a complex mixture composed of short and long hair as well as the presence of contaminants such as dust, dander, nails and other unidentified components. The use of this complex mixture was selected as the worst-case scenario; and as such, as the best option to evaluate the reduction of pet hair adherence to fabrics.

In order to determine the best way to evaluate the benefit, different types of fabric and pet hair adhesion methods are used to determine the best conditions to perform the evaluations. Fabrics were selected taking into consideration its manufacturing materials, its popularity and the differences in manufacturing techniques employed for its construction to evaluate the effect that color, composition and surface roughness could have on benefit perception. Fabrics selected were cardigan; denim and cotton.

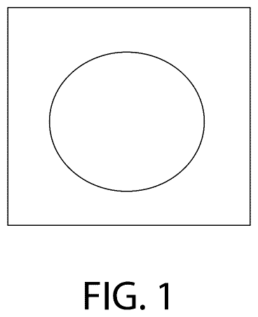

For the analysis, 15 cm×15 cm squares are cut from each fabric type and marked with a 11.5 cm diameter circle. This circle is drawn in order to define an exposure area between pet hair and fabric. Similarly, the evaluation of the amount of pet hair adhered to the fabric is restricted within the defined area (see, FIG. 1).

For fabrics exposure to pet hair, direct contact between hair and fabrics is forced. Three different methods for pet hair adhesion are evaluated to determine the best conditions to get the most reproducible results.

Table 2 (below) describes the methods employed. Methods were identified as: A) Light; B) Medium; and C) Hard, to express the degree of physical contact between pet hair and fabric. For pet hair handling, rubber gloves were used to promote static formation on the pet hair before deposition on fabrics. Big contaminants such as nails and dirt particles were removed manually as well as any hair entanglement detected.

TABLE 2

| | Amount of | Contact Time with | |
|---|---|---|---|
| Method | Hair used (g) | fabric (sec) | Type of [Pet-hair] - [Fabric] interaction |
| A | 1 | 60 | Light: Pet-Hair is deposited in the fabric covering |
| | | | the entire circle area. Once the entire area is |
| | | | covered, a 300 g weight stainless steel container is |
| | | | put over the hair for 10 seconds, then removed |
| | | | and let the Pet-Hair in contact with the fabric by |
| | | | remaining 50 seconds. Pet-Hair is removed by 10 |
| | | | seconds of manual shaking. |
| B | 1 | 60 | Medium: Pet-Hair is deposited in the fabric |
| | | | covering the entire circle area. Once the entire |
| | | | area is covered, a stainless steel container is used |
| | | | to cover the Pet-Hair (without pressure applied). |
| | | | Then a circular movement was applied all over |
| | | | the circle area to rub the hair on the area by 60 |
| | | | seconds. |
| C | 1 | 60 | Hard: Pet-Hair is deposited in the fabric covering |
| | | | the entire circle area. Once the entire area is |
| | | | covered the Pet-Hair is pressed against the fabric |
| | | | employing a PET cap wrapped in aluminum foil. |
| | | | Then a circular movement was applied all over |
| | | | the circle area to rub the hair on the area by 60 |
| | | | seconds. |

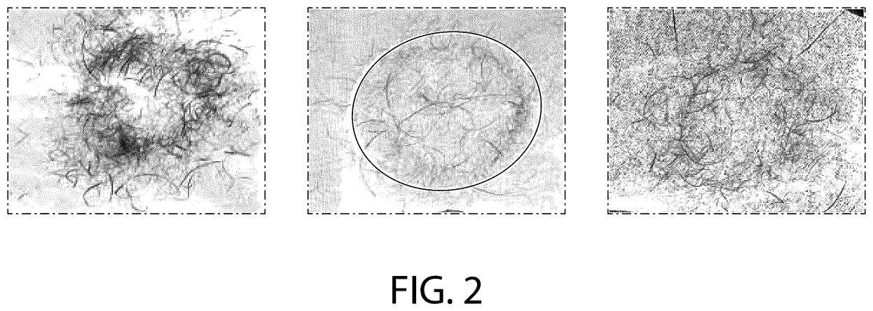

Pet hair adhered to every fabric tested (denim, cardigan and black cotton), however, black cotton fabric allowed the best contrast and so facilitated the visual evaluation of fabrics (see, FIG. 2).

Regarding different methods for pet hair adherence, method A allowed better reproducibility for pet hair deposition because there was less handling required for its exclusion. Thus, for the rest of the evaluations, cotton fabrics and method A were employed for pet hair deposition on fabric and further evaluation for benefit.

### Example 2

Benefit evaluation was done by determining the amount of pet hair adhered to fabrics after being treated with the exemplary compositions of the present invention.

TABLE 3

| Parameter | Conditions | |
|---|---|---|
| Water Volume | 60 | L |
| Wash Load Size | 2.5 | Kg |

| | |
|---|---|
| Type of Laundry Detergent | Ariel Dobel Poder Powder (P&G) |
| Liquid Fabric Softener Dosage | 34 mL/wash load |
| Dryer Sheet | 1 dryer sheet/wash load |
| Water Hardness | Tap water (no hard water used) |
| Drying Setup | Tumble dryer, 1 hour |

Groups of black cotton fabrics (15 cm×15 cm) are treated individually with the doses described in Table 3 (above). Divide black cotton fabrics into groups, one group per each formula to be tested. Conduct individual washes employing the conditions shown in Table 3 (above) so each group of samples is washed employing an exemplary composition of the present invention. Fabrics are dried in a tumble dryer for at least one (1) hour or until completely dried. Mark a 11.5 cm circle on each fabric to define the area in contact with pet hair. Samples are stored on aluminum foil until use.

The handling of fabrics and pet hair is done employing lab gloves all time. The procedure for pet hair adhesion to fabrics is as follows:
1. Weigh 1 g pet hair
2. Remove any big particle, adhesive material or any other contaminant from the sample (adjust weight if necessary).
3. Put a piece of black cotton fabric, previously treated with an exemplary composition of the present invention, on a flat surface.
4. Take the pet hair with your hands (lab gloves on) and unravel the pet hair to avoid big entanglements to be deposited on the fabrics (confusion factor for visual evaluations).
5. Deposit the pet hair, on the black cotton fabric, in the marked circle area trying to cover the entire inner surface avoiding depositing pet hair outside the circle.
6. Put a three hundred grams (300 g) weight on the pet hair for ten (10) seconds. Remove the weight and let it rest for fifty (50) seconds.
7. Remove the pet hair manually by taking the fabric from two corners and slightly shaking for ten (10) seconds.
8. Cover the fabric with aluminum foil to avoid pet hair to be removed by wind.

Visual evaluations were conducted employing the 2AFCM (Two Alternative Forced Choice Method). It consists of showing to untrained panelists a pair of fabrics with Pet Hair on them. Participants are asked to choose the piece of fabric with more hair on it.

For assessing the hair adhesion benefit score, the sample selected as the one with more hair is scored with the number 2, while the sample with less hair is scored with the number 1. At the end, a frequency analysis is done to define which sample has the higher hair adhesion benefit score (more times selected as the hairiest). The higher the hair adhesion benefit score, the more hair is adhered to the fabric and less benefit is perceived by panelists.

In order to evaluate the possible benefits of liquid fabric softener formulas, simultaneous evaluations employing different treatments were conducted. Treatments tested included:
1. Detergent Only
2. Exemplary liquid composition of the present invention
3. Dryer Sheets

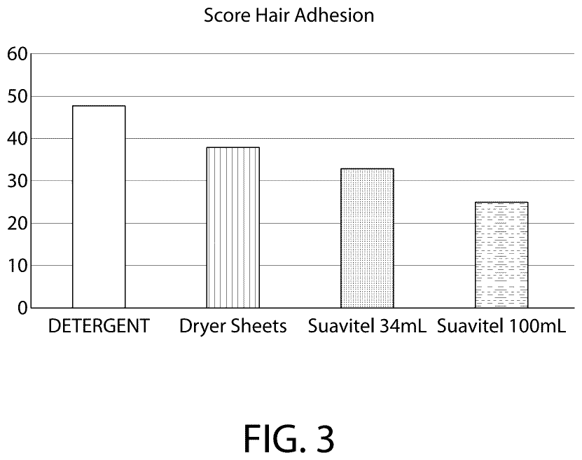

Washings employing black cotton fabrics are done according to the conditions described in table 3. Pet hair adhesion and evaluation (2AFC method) were conducted as described above. Every treatment was evaluated 24 times, 8 times against every single treatment. For example, the detergent was compared eight (8) times against an exemplary composition of the present invention (Example Composition 3), eight (8) times against dryer sheets and eight (8) times against an exemplary composition of the present invention (with a superior dosage). The results are shown in Table 4 (below) and FIG. 3.

TABLE 4

| Formula | Detergent | Dryer Sheet | Ex. 3 | Ex. 3 |
|---|---|---|---|---|
| Score | 48 | 38 | 33 | 25 |

As can be seen from the FIG. 3, an exemplary composition of the present invention is far superior to detergent; and also demonstrates a meaningful difference over dryer sheets.

### Example 3

Hair Adhesion Benefit Score estimates the reduction of pet hair adhered to fabrics. The lower the score, the better the benefit. The impact of certain ingredients on pet hair adhesion is evaluated.

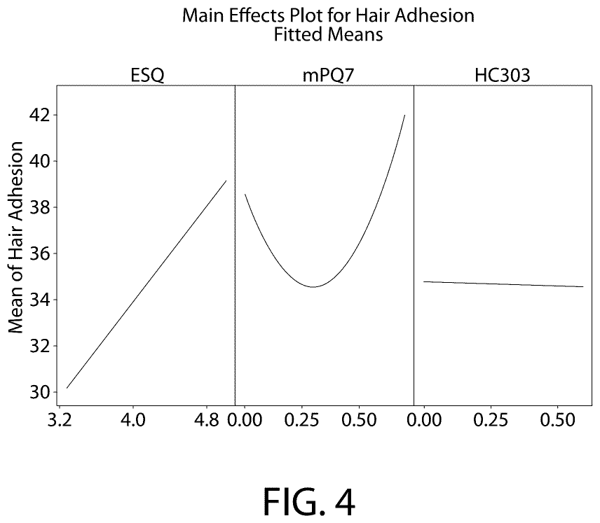

As shown in FIG. 4, the higher the amount of esterquat (ESQ), the lower the benefit (more hair adheres). On the other hand, the modified polyquaternium-7 (mPQ7) shows a curved behavior that could be associated with its polyelectrolyte nature. As the amount of this component increases, so does the conductivity in the surface and with it, the dissipation of electrical charge. However, if the concentration keeps going higher, it might be possible to get an excess of positive charge on the fabric's surface that instead of helping at reducing pet hair adhesion tends to promote its adherence due to the formation of a high potential difference between fabrics and pet hair, which without being limited to any particular theory is believed to be the main reason for static charge formation.

Hair Adhesion Benefit Scores for various combinations of ESQ, mPQ7, and a silicone are evaluated. The results are described below in Table 5.

TABLE 5

| | | | | Silsoft | Hair Adhesion Benefit |
|---|---|---|---|---|---|
| Prototype | ESQ | mPQ7 | HC303 | CLX-E | Score - Hair Adhesion |
| 1 | 3.271 | 0.7 | — | 0.3 | 37 |
| 2 | 4.138 | — | — | — | 43 |
| 3 | 3.271 | 0.7 | 0.6 | — | 40 |
| 4 | 4.138 | 0.7 | 0.6 | 0.6 | 49 |
| 5 | 3.271 | 0.35 | — | 0.6 | 28 |
| 6 | 5.006 | — | — | 0.6 | 51 |
| 7 | 5.006 | 0.7 | — | — | 40 |
| 8 | 3.271 | — | 0.3 | — | 30 |
| 9 | 4.138 | 0.35 | 0.3 | 0.3 | 36 |
| 10 | 5.006 | 0.7 | 0.3 | 0.6 | 44 |
| 11 | 5.006 | 0.35 | 0.6 | — | 40 |
| 12 | 3.271 | — | 0.6 | 0.6 | 32 |
| 13 | 5.006 | — | 0.6 | 0.3 | 37 |
| 14 | 3.271 | 0.342 | — | — | 39 |

ESQ: Dialkylester triethanol ammonium methyl sulfate (Esterquat)
mPQ7: Polyquaternium 7 modified
HC303: silicone
SILSOFT CLX-E: silicone

### Example 4

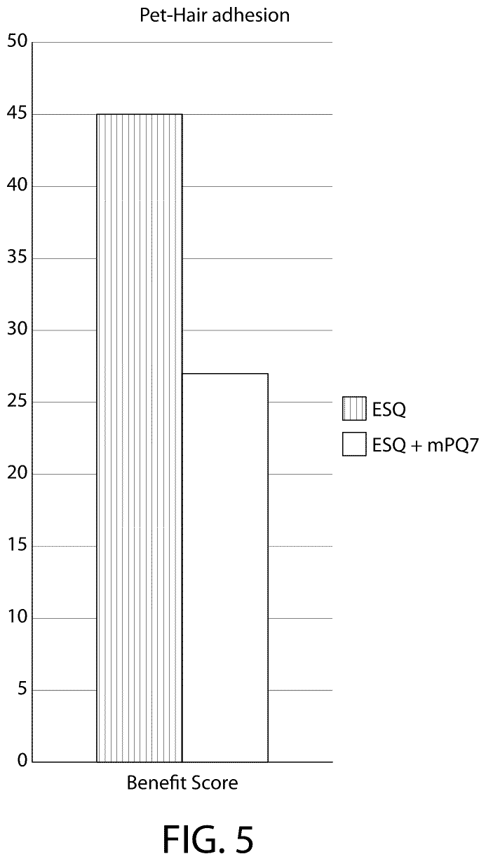

A 2AFCM evaluation is conducted to compare hair adhesion benefit scores between ESQ based technology (Comp. Ex. 1) and an exemplary composition of the present invention (ESQ+mPQ7). The results are described in FIG. 5.

### Example 5

To evaluate the benefits of exemplary liquid fabric care compositions of the present invention, simultaneous evaluations employing different treatments were conducted in both dog and cat hair. Treatments tested are described in Table 6 (below). Each treatment included one washing with detergent (Comp. Ex. 2). The remaining treatments included either the use of a dryer sheet (Comp. Ex. 3), or the use of an exemplary composition of the present invention (Ex. 4).

TABLE 6

| | # Black | | |
|---|---|---|---|
| | Cotton | | |
| | Squares | Wash | Washes, Detergent & Fabric |
| Sample | Washed | Load | Softener Dosages |
| Comp. Ex. 2 | 6 | 2.5 Kg | # of washes: 1 |
| (Tide ® Liquid | | | Detergent: 100 mL |
| (P&G)) | | | Fabric Softener: 0 mL |
| Comp. Ex. 3 | 6 | 2.5 Kg | # of washes: 1 |
| (Dryer Sheet | | | Detergent: 100 mL |
| Bounce, Pet Hair | | | Dryer Sheet: 1/wash load |
| & Lint Guard) | | | |
| Ex. 4 | 6 | 2.5 Kg | # of washes: 1 |
| | | | Detergent: 100 mL |
| | | | Fabric Softener: 34 mL/wash load |
| Ex. 4 | 6 | 2.5 Kg | # of washes: 5 |
| | | | Detergent: 100 mL |
| | | | Fabric Softener: 34 mL/wash load |

* Ex. 4 is evaluated in 1 single wash and 5 cumulative washes

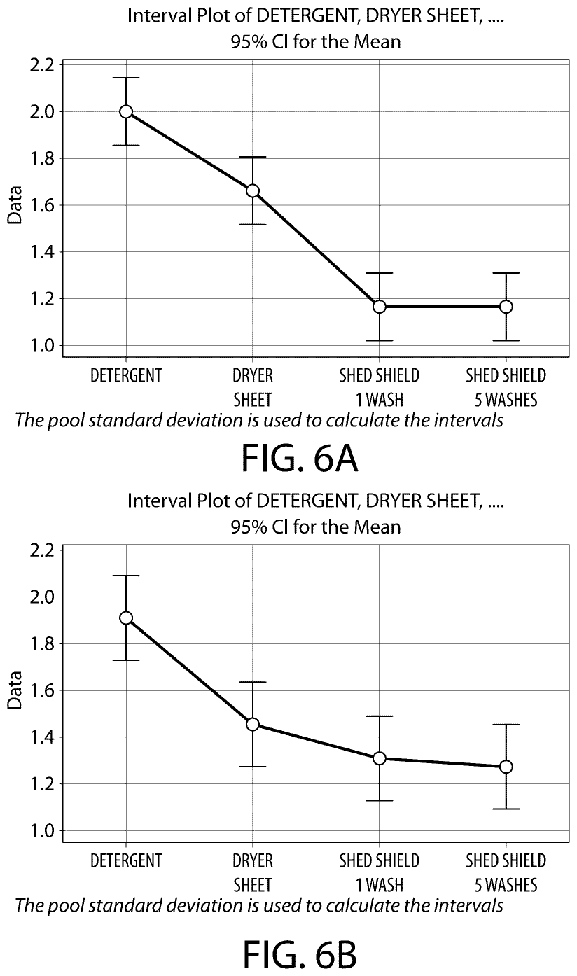

As shown in FIGS. 6A and 6B, hair adhesion benefit scores for both dog and cat hair evaluations are shown. From the figures, it can be seen that there is a lower amount of pet hair adhered to fabrics after treatment with an exemplary composition of the present invention.

Similar trends can be seen in both evaluations, the samples treated with detergent only (Comp. Ex. 2) are selected as the ones with the higher amount of pet hair adhered. Dryer Sheets (Comp. Ex. 3) followed as the second “hairiest” sample. Remarkably, an exemplary composition of the present invention (Ex. 4) demonstrated the lowest amount of pet hair adhered to the fabrics.

### Example 6

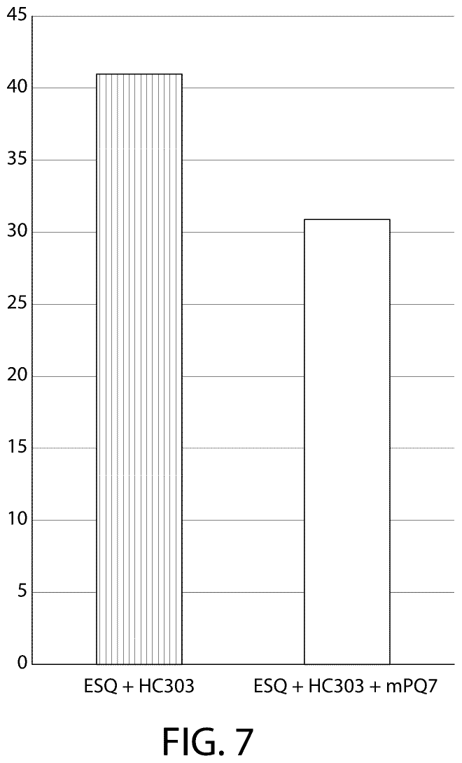

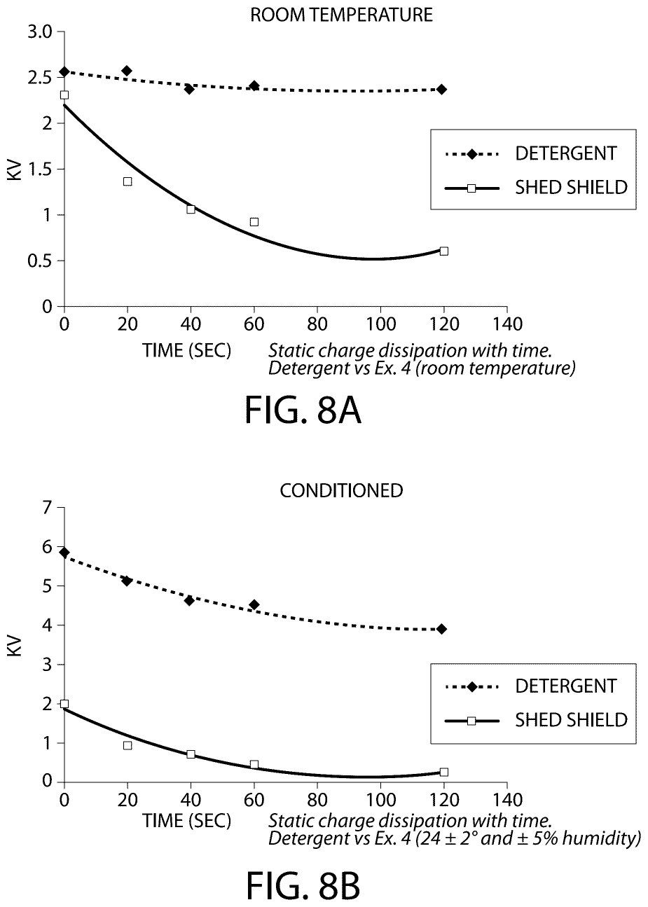

A 2AFCM evaluation is conducted to compare hair adhesion benefit scores between two exemplary compositions of the present invention—one based on ESQ+silicone technology (Ex. 4); and one based on ESQ+silicone+mPQ7 technology (Ex. 5). The results are described in FIG. 7.

### Example 7

Acrilan swatches are washed. After one single wash, acrilan swatches are dried in a tumble dryer by 1 h before the test. Initial static charge and static charge dissipation are measured employing a 3M 718 Static Sensor. Dried acrilan swatches are rubbed twenty (20) times with a balloon for static charge formation and five (5) individual measurements (in kV) are done following 3M 718 Static Sensor manufacturer instructions. The main measurement scheme can be seen in table 1, where continuous measurements through time were taken so both, initial and dissipation rate of charge can be measured.

TABLE 7

| | Measurement | | | | |
|---|---|---|---|---|---|
| | Time | Time | Time | Time | Time |
| | 0 sec | 20 sec | 40 sec | 60 sec | 120 sec |
| Comp. | Initial | kV | kV | kV | Final |
| Ex. 2 | charge kV | | | | Charge kV |
| Ex. 4 | Initial | kV | kV | kV | Final |
| | charge kV | | | | Charge kV |

The effect of environmental humidity is tested to check for any significant variation due to moisture absorption. Data is collected and plotted for comparison.

The results are described in Table 8 (below). Two treatments and two environmental conditions are tested and the static charge in KV is measured and compared between treatments.

As demonstrated by the data described in Table 8 (below), static charge is lower after treatment with an exemplary composition of the present invention. In addition, static charge dissipation shows that the electrical charge present on the surface is reduced faster after treatment with an exemplary composition of the present invention as compared to treatment with detergent only.

TABLE 8

| | | TIME (SECONDS) | | | | | | | | | |
|---|---|---|---|---|---|---|---|---|---|---|---|
| ENVIRONMENT | TREATMENT | 0 | | 20 | | 40 | | 60 | | 120 | |
| ROOM TEMP | DETERGENT | 2.55 | KV | 2.56 | KV | 2.36 | KV | 2.4 | KV | 2.36 | KV |
| | Ex. 4 | 2.32 | KV | 1.37 | KV | 1.06 | KV | 0.92 | KV | 0.6 | KV |
| CONDITIONED | DETERGENT | 5.8 | KV | 5.1 | KV | 4.6 | KV | 4.5 | KV | 3.91 | KV |
| Conditioning chamber/ | Ex. 4 | 2 | KV | 1 | KV | 0.71 | KV | 0.5 | KV | 0.28 | KV |
| room 25 ± 2° C. and | | | | | | | | | | | |
| 50 ± 5% relative | | | | | | | | | | | |
| humidity | | | | | | | | | | | |

### Example 8

A consumer at home evaluation was conducted to assess Example Composition 1. The consumer at home evaluation included 340 volunteers, with approximately an equal number of male and female volunteers, that presently have a canine or feline residing in the volunteer's residence. Specifically, each volunteer was instructed to wash their clothes and/or fabrics for two weeks using only a fabric detergent. After the two-week period of washing their clothes and/or fabrics with only a fabric detergent, the volunteers were given samples of Example Composition 1 for use over a two-week period in accordance with typical instructions for using a fabric conditioner. The volunteers were surveyed after using Example Composition 1 for the two-week period.

Based on the analyzed surveys, 74.7% of the volunteers determined that Example Composition 1 yielded fabrics and/or clothes that repelled pet hair, while 8.5% of volunteers concluded that Example Composition 1 did not yield fabrics and/or clothes that repelled pet hair better than using the fabric detergent alone and 16.8% of volunteers were unsure if Example Composition yielded better than using a fabric detergent alone.

### Example 9

A benefit evaluation was done by determining the amount of pet hair adhered to fabric swatches after being treated with Exemplary Composition 1 in accordance with the procedures described in the above Examples. Specifically, a predetermined amount of hair, either canine hair or feline hair, was applied to fabric swatches containing 50% cotton and 50% polyester. The fabric swatches were subsequently washed with detergent only (Comp. Ex. 2) or with a detergent (Tide® Liquid (P&G)) and Example Composition 1, under the following conditions: a water volume of 60 L; a wash load size comprising the fiber swatches plus an amount of cotton T-shirts to have a wash load size of 2.5 Kg; 27 mL of detergent per wash load; and optionally 34 mL of Example Composition 1 per wash load. The fabric swatches and T-shirts were then tumble dried for one hour.

The fabrics were then visually evaluated and a one proportion z-test was used to compare an observed proportion to a theoretical one at 95% confidence level using the following equation:

$$z = ( p - p 0 ) / √ ( p 0 ( 1 - p 0 ) / n )$$

where: p=observed sample proportion; p0=hypothesized population proportion; and n=sample size.

A summary of the results of the benefit evaluation are shown in Tables 9-12.

TABLE 9

| | | Comp. Ex. 2 | |
|---|---|---|---|
| | Comp. | & Example | No |
| Dog hair 1 | Ex. 2 | Composition 1 | Difference |
| Original Data | 92% | 6% | 3% |
| Split Equally | 93% | 8% | 0% |

| | |
|---|---|
| z-statistic | 9.42 |
| p-value (one-tailed) | 0 |
| p-value (two-tailed) | 0 |

Significant difference at 95% confidence

TABLE 10

| | | Comp. Ex. 2 | |
|---|---|---|---|
| | Comp. | & Example | No |
| Cat hair 1 | Ex. 2 | Composition 1 | Difference |
| Original Data | 98% | 3% | 0% |
| Split Equally | 98% | 3% | 0% |

| | |
|---|---|
| z-statistic | 10.52 |
| p-value (one-tailed) | 0 |
| p-value (two-tailed) | 0 |

Significant difference at 95% confidence

TABLE 11

| | | Comp. Ex. 2 | |
|---|---|---|---|
| | Comp. | & Example | No |
| Dog hair 2 | Ex. 2 | Composition 1 | Difference |
| Original Data | 98% | 3% | 0% |
| Split Equally | 98% | 3% | 0% |

| | |
|---|---|
| z-statistic | 10.52 |
| p-value (one-tailed) | 0 |
| p-value (two-tailed) | 0 |

Significant difference at 95% confidence

TABLE 12

| | | Comp. Ex. 2 | |
|---|---|---|---|
| | Comp. | & Example | No |
| Cat hair 2 | Ex. 2 | Composition 1 | Difference |
| Original Data | 99% | 1% | 0% |
| Split Equally | 99% | 1% | 0% |

| | |
|---|---|
| z-statistic | 10.74 |
| p-value (one-tailed) | 0 |
| p-value (two-tailed) | 0 |

Significant difference at 95% confidence

The present disclosure has been described with reference to exemplary embodiments. Although a few embodiments have been shown and described, it will be appreciated by those skilled in the art that changes may be made in these embodiments without departing from the principles and spirit of preceding detailed description. It is intended that the present disclosure be construed as including all such modifications and alterations insofar as they come within the scope of the appended claims or the equivalents thereof.

1. A liquid fabric care composition comprising:
dialkylester triethanol ammonium methyl sulfate;
a silicone or a copolymer of acrylamide and diallyldimethylammonium chloride; and
greater than about 50 wt. % water,
for use in reducing or preventing the adhesion of pet hair to a fabric.

2. The liquid fabric care composition according to claim 1, comprising from about 0.5 wt. % to about 5 wt. % of a dialkylester triethanol ammonium methyl sulfate.

3. The liquid fabric care composition according to claim 1, comprising from about 1 wt. % to about 4 wt. % of a dialkylester triethanol ammonium methyl sulfate.

4. (canceled)

5. The liquid fabric care composition according to claim 1, comprising from about 0.1 wt. % to about 1 wt. % of a silicone.

6. The liquid fabric care composition according to claim 1, comprising from about 0.25 wt. % to about 0.5 wt. % of a silicone.

7. The liquid fabric care composition according to claim 1, wherein the copolymer of acrylamide and diallyldimethylammonium chloride is modified.

8. The liquid fabric care composition according to claim 7, wherein the copolymer of acrylamide and diallyldimethylammonium chloride is modified with a linear or branched hydrocarbon.

9. The liquid fabric care composition according to claim 1, comprising from about 0.01 wt. % to about 2 wt. % of a copolymer of acrylamide and diallyldimethylammonium chloride.

10. The liquid fabric care composition according to claim 1, comprising from about 0.05 wt. % to about 1.5 wt. % of a copolymer of acrylamide and diallyldimethylammonium chloride.

11. (canceled)

12. The liquid fabric care composition according to claim 1, comprising from about 0.2 wt. % to about 0.5 wt. % of a copolymer of acrylamide and diallyldimethylammonium chloride.

13. (canceled)

14. The liquid fabric care composition according to claim 1, further comprising a thickening system comprising an acrylate copolymer.

15. The liquid fabric care composition according to claim 14, wherein the thickening system comprises from about 0.01 wt. % to about 2 wt. % of an acrylate copolymer.

16. (canceled)

17. The liquid fabric care composition according to claim 14, wherein the thickening system comprises from about 0.1 wt. % to about 1.0 wt. % of an acrylate copolymer.

18. (canceled)

19. (canceled)

20. The liquid fabric care composition according to claim 1, comprising from about 50 wt. % to about 99 wt. %, water.

21. The liquid fabric care composition according to claim 1, comprising from about 75 wt. % to about 98 wt. %, water.

22. The liquid fabric care composition according to claim 1, comprising from about 85 wt. % to about 97 wt. %, water.

23. (canceled)

24. The liquid fabric care composition according to claim 1, wherein the liquid fabric care composition reduces the electrostatic force between pet hair and a fabric.

25. The liquid fabric care composition according to claim 1, wherein the liquid fabric care composition provides a Hair Adhesion Benefit Score of less than 50.

26. A liquid fabric care composition comprising:
water;
a dialkylester triethanol ammonium methyl sulfate; and
an effective amount of an anti-adhesion component comprising:
a silicone, and/or
a copolymer of acrylamide and diallyldimethylammonium chloride,
wherein the anti-adhesion component is present in an amount effective to reduce the adhesion of pet hair to a fabric.

27-31. (canceled)

32. A method of reducing or preventing the adhesion of pet hair to a fabric, the method comprising:
applying to a fabric a liquid composition comprising:
water,
a dialkylester triethanol ammonium methyl sulfate; and
an effective amount of an anti-adhesion component comprising:
a silicone; and/or
a copolymer of acrylamide and diallyldimethylammonium chloride,
wherein the anti-adhesion component is present in an amount effective to reduce the adhesion of pet hair to a fabric.
